(19) United States
(12) Patent Application Publication
(10) Pub. No.: US 2007/0092333 A1
(43) Pub. Date: Apr. 26, 2007

(54) Apparatus for securely yet removably installing an ornament onto a substantially planar surface

(76) Inventors: Tom Viscount, Santa Monica, CA (US); John Wadsworth, Los Angeles, CA (US); Craig Janik, Loyola Corners, CA (US)

Correspondence Address: CISLO & THOMAS, LLP, 233 WILSHIRE BLVD, SUITE 900, SANTA MONICA, CA, 90401-1211, US

(21) Appl. No.: 11/638,151

(22) Filed: Dec. 12, 2006

Related U.S. Application Data
(63) Continuation-in-part of application No. 10/355,093, filed on Jan. 31, 2003, now Pat. No. 7,147,399.
Application No. 10/355,093 is a continuation-in-part of application No. 09/713,139, filed on Nov. 14, 2000, now abandoned.
(60) Provisional application No. 60/164,910, filed on Nov. 15, 1999.

(51) Int. Cl. F16B 7/20

(52) U.S. Cl. 403/349

(57) ABSTRACT

An apparatus for attaching ornaments onto substantially planar surfaces such as a vehicle, automobile, or the like, comprising, a mounting base with an aperture, a coupling device with attachment means and an ornament. The mounting based has a curved surface and is securely attachable to a substantially planar surface. The coupling device is securely or detachably attachable to the mounting base and the ornament is securely or detachably attachable to the coupling device.

### CROSS-REFERENCES TO RELATED APPLICATIONS

This application is a continuation-in-part of U.S. patent application Ser. No. 10/355,093 filed Jan. 31, 2003, now U.S. Pat. No. 7,147,399, which is a continuation-in-part of U.S. application Ser. No. 09/713,139 filed Nov. 14, 2000 which claims priority to U.S. Provisional Application Serial No. 60/164,910 filed Nov. 15, 1999.

### BACKGROUND OF THE INVENTION

1. Field of the Invention

The present invention relates generally to a unique method for installation and placement of an ornament, and more particularly to a unique method of securely yet removable attaching an ornament onto a substantially planar surface. Such surfaces include snowboards, helmets, related sports accessories, motorcycles, bicycles, automobiles, trucks, vehicles, sport utility vehicles, computer monitors, as well as other articles that have substantially planar surfaces.

2. Description of the Related Art

Skateboarding, snowboarding and the like have become increasingly popular during the past years. Many people participating in these activities purchase their own equipment and use this equipment for extended periods of time. It is not uncommon that participants become extremely attached to their equipment and at some point decorate their equipment to their liking. At present, decals and drawings placed on equipment, so that people can personalize them, is quite commonplace. Also, because the younger generation is more likely to participate in these activities, and because many participation and spectator events are temporal or seasonal, it is quite possible that those participants would desire a change of decals and/or drawings from week to week, even sometimes from day to day. Therefore, it would be highly desirable to provide an apparatus which can be attached to substantially planar surfaces which would provide the ability to securely attach, yet removably attach, ornaments and the like so that the user could interchange these at any time.

The present invention provides an improvement for customizing sporting equipment and the like which achieves these goals. In brief summary, the present invention allows for an ornament to be securely yet removably attached to a base and allows for the interchange of this ornament at the users desire.

### SUMMARY OF THE INVENTION

A method for customizing planar surfaces, such as on vehicles, automobiles or the like, bicycles, motorcycles, sport utility vehicles, snowboards, skateboards and the like comprising a mounting base with attachment means attached to a substantially planar surface, a detachably attachable coupling device and an ornament or the like.

In order to accomplish this goal, what is needed is an apparatus that allows the ability to attach and detach ornaments and the like from a base, which is attached to a substantially planar surface, quickly and easily such that, when attached, the ornament is securely attached to the base.

In particular, one embodiment of the invention is directed to a system where the attachment means is a bayonet fit mount of a rigid material. In another embodiment, the attachment means is a snap fit mount of a rigid material. In yet another embodiment, the attachment means is an interference fit using an elastomeric material.

An object of this invention is to allow the end user the ability to easily and interchangeably customize such surfaces. Another object of this invention is to allow the end user the ability for these changes to be done rather quickly. These and other objects and advantages of the present invention will be apparent from a review of the following specification and accompanying drawings.

### BRIEF DESCRIPTION OF THE DRAWINGS

FIG. 1 is a perspective view of one embodiment of the present invention.

FIG. 2 is a perspective view of another embodiment of the present invention.

FIG. 3 is a perspective view of another embodiment of the present invention.

FIG. 4 is a perspective view of the preferred embodiment of the present invention.

FIG. 5 is a perspective view of the mounting base of the present invention.

FIG. 6 is a perspective view of the bayonet type fitting and a cross-sectional view of the mounting base of the present invention.

FIG. 7 is a perspective view of the snap-fit type fitting and a cross-sectional view of the mounting base of the present invention.

FIG. 8 is a perspective view of the interference type fitting and a cross-sectional view of the mounting base of the present invention.

FIG. 9 is a perspective view of another embodiment of the present invention.

FIG. 10 is a perspective view of another embodiment of the present invention.

FIG. 11 is a perspective view of an embodiment of the present invention with an alternative ornament.

FIG. 12 is a perspective view of another embodiment of the present invention.

FIG. 13 is a perspective view of one example of a coupling device in keeping with the present invention.

FIG. 14 is a cross-sectional view of a coupling device and mounting base in keeping with the present invention.

FIG. 15 is a cross-sectional view of the coupling device and mounting base of FIG. 14, in which the coupling device and mounting base have both been rotated 90°.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

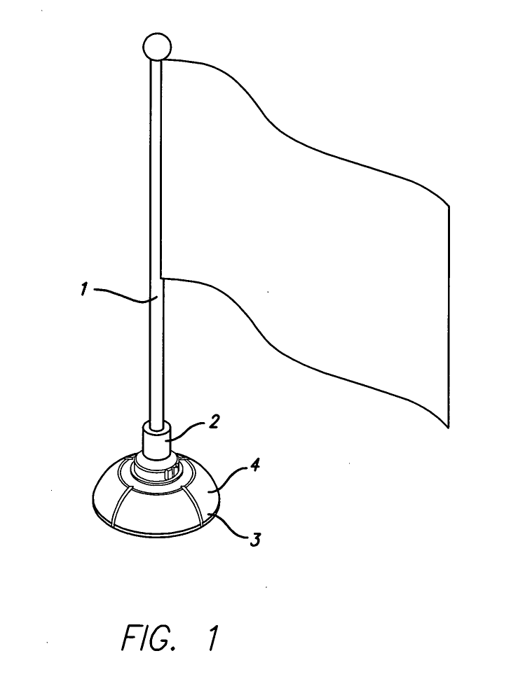

In FIG. 1, one embodiment of the present invention is shown. An ornament 1 is securely connected to a coupling device 2, which is securely connected to a mounting base 3. The mounting base 3 had a curved upper surface 4 and a generally planar undersurface (not shown). In this embodiment the securely connected elements can be either rigid or flexible. The mounting base 3 is securely attached to a substantially planar surface (not shown) by way of a pressure sensitive adhesive (not shown). Examples of substantially planar surfaces, while not limiting to, are snowboards, helmets, related sports accessories and computer monitors.

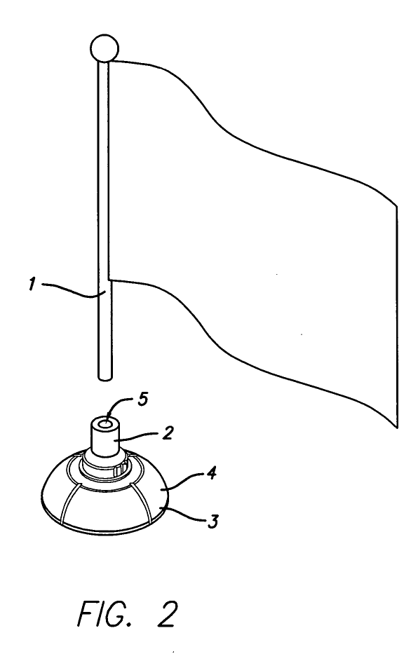

In FIG. 2, another embodiment of the present invention is shown. In this embodiment, the coupling device 2 is securely connected to the mounting base 3 and has an opening 5 allowing an ornament 1 to be removably attached. This allows the ornament 1 to be removed and replaced, either for a different function, or if the object is decorative, based on the fashion of the moment. In this embodiment, the ornament 1 can be flexible, while the coupling device 2 and the mounting base 3 are rigid. The ornament 1 need not be flexible, however, but can be a rigid object as well.

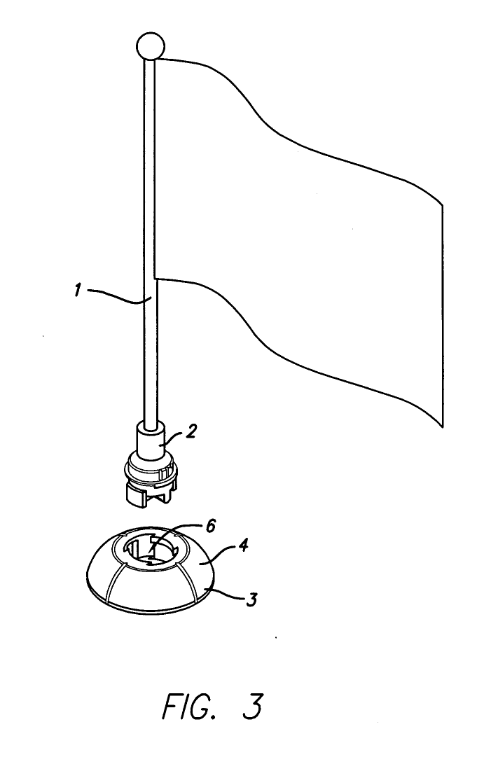

FIG. 3 represents yet another embodiment of the present invention. In this embodiment, the ornament 1 is securely connected to the coupling device 2. However, the coupling device 2 is removably attachable to the mounting base 3. The mounting base 3 contains an aperture 6 allowing for the attachment of the coupling device 2. In this embodiment the coupling device 2 and ornament 1 combination is flexible and the mounting base 3 is rigid. However, the coupling device 2 and ornament 1 combination may be rigid as well. This embodiment also allows for the user to quickly and efficiently alter the decoration of their product.

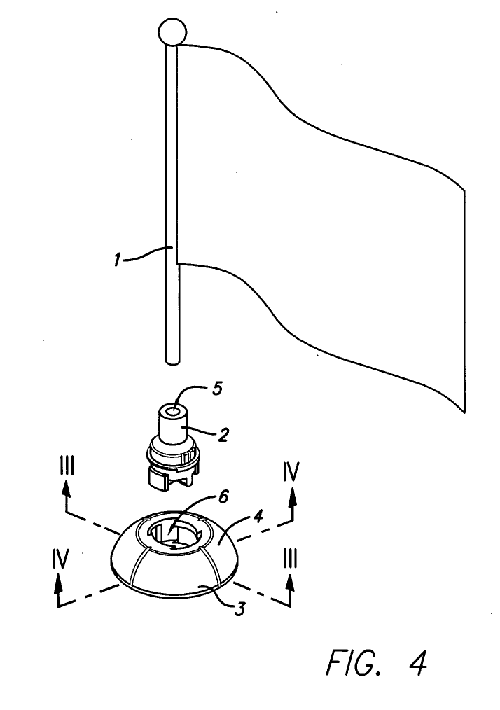

FIG. 4 represents the preferred embodiment of the present invention. In this embodiment the mounting base 3 and the coupling device 2 are removably attachable to one another and the coupling device 2 and the ornament 1 are removably attachable to one another. This embodiment is the most accommodating for the user as it allows for the most flexibility of the ability to interchange parts. Not only would it allow users to interchange ornaments 1, but would also allow users the ability to interchange coupling devices 2 that had ornaments 1 already securely attached. In the preferred embodiment, the ornament 1 and the mounting base 3 are rigid, while the coupling device 2 flexible. However, the ornament 1 or the mounting base 3 need not be rigid, they may be flexible as well.

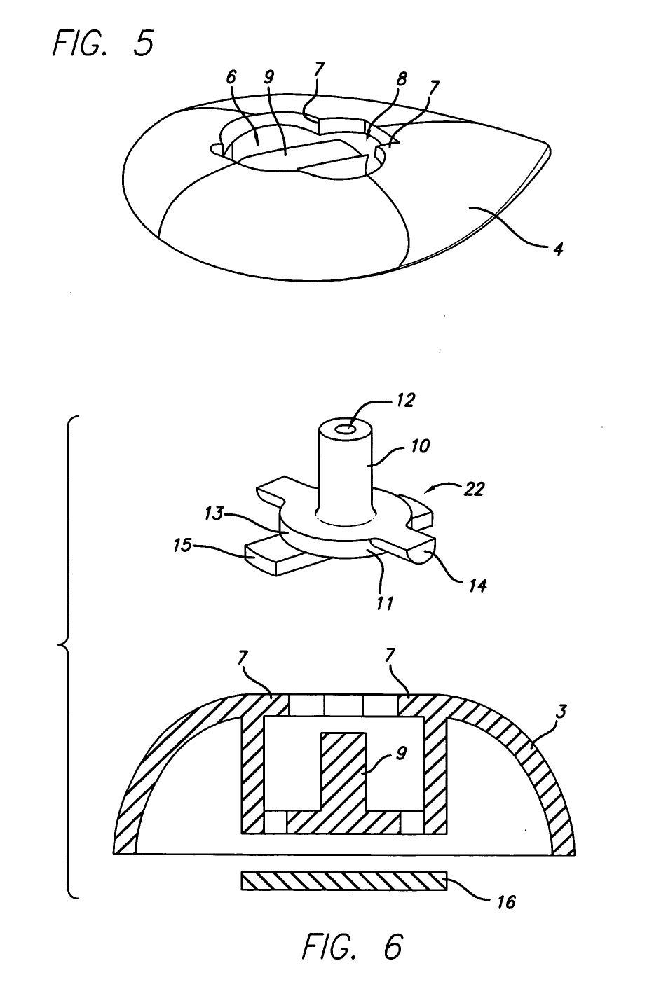

In FIG. 5, the mounting base 3 is shown. The mounting base 3 has an aperture 6 with lips 7. The lips 7 are formed by an extension of the curved upper surface 4 of the mounting base 3 beyond the aperture 6. There are two diametrically opposed gaps 8 adjacent to the lips 7. Also, a rib 9 is located in the center of the aperture 6, which is used to set the orientation of the coupling device (not shown). This rib 9 is in line with the diametrically opposed gaps 8. The mounting base 3 could also be modified, by the addition of a hole, for attachment using screws or other mechanical fasteners.

FIGS. 6, 7, 8 show the different embodiments of the coupling devices 22, 32, 42. The attachment of the coupling devices 22, 32, 42 and the mounting base 3 can be accomplished several ways. The current invention allows for either bayonet 22 or snap-fit 32 mounts in a rigid material or an interference fit by using an elastomeric material mount 42.

FIG. 6 shows one embodiment of the coupling device 2 and a cross-sectional view of the mounting base 3. The bayonet mount 22 comprises an upper portion 10 and a lower portion 11. The upper portion 10 of the bayonet mount 22 comprises an opening 12 and a circular disc 13 with horizontal extensions 14 rotatably attached to a base 15 on the lower portion 11 of the bayonet mount 22. The base 15 of the bayonet mount 22 is placed into the mounting base 3 by aligning the base 15 with the rib 9 of the mounting base 3. The bayonet mount 23 can be securely attached to the mounting base 3 by rotating the circular disc 13 through a given angle having the horizontal extensions 14 fit under the lips 7 and achieve a tight fit, preferably incorporating some kind of positive locking action. The mounting base 3 securely attaches to a substantially planar surface (not shown) by an adhesive 16. Such examples of adhesives are Velcro or double sided tape, as in the preferred embodiment. In other embodiments the mounting base 3 can be attached to a substantially planar surface (not shown) by screws or metal fasteners.

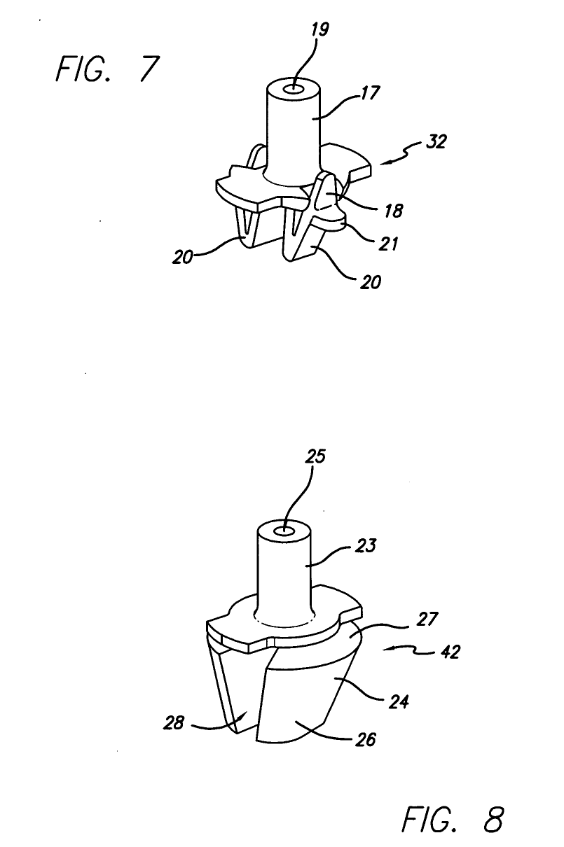

FIG. 7 shows another embodiment of the coupling device 2. The snap fit mount 32 is composed of an upper portion 17 and a lower portion 18. The upper portion 17 has an opening 19 and the lower portion 18 has two arms 20 which extend from the upper portion 17 and bend back on themselves. These arms 20 have projections 21. When the snap fit mount 32 is pressed into the mounting base 3, the projections 21 engage the lips. 7 on the mounting base 3. This type of mount is more rigid and can bear a larger load than the elastomeric mount 42. It is also somewhat more secure than the bayonet type mount 22.

FIG. 8 shows yet another embodiment of the coupling device 2. The elastomeric mount 42 is composed of an upper portion 23 and a lower portion 24. The upper portion 23 contains an opening 25. The lower portion 24 comprises a cone shaped projection 26 with a small step 27. There is also a slot 28, bisecting the cone shaped projection 26. This allows the elastomeric mount 42 to be positioned in one of two orientations relative to the rib 9 in the center of the mounting base 3. This approach uses the material properties to allow the elastomeric mount 42 to be pressed into place once it has been aligned to the rib 9. The material will compress pass the lips 7 and will then expand under the lips 7, thereby locking the elastomeric mount 42 in place. Removal is accomplished by “peeling” the elastomeric mount 42 out of the mounting base 3 in the direction of the slots on the lips 7.

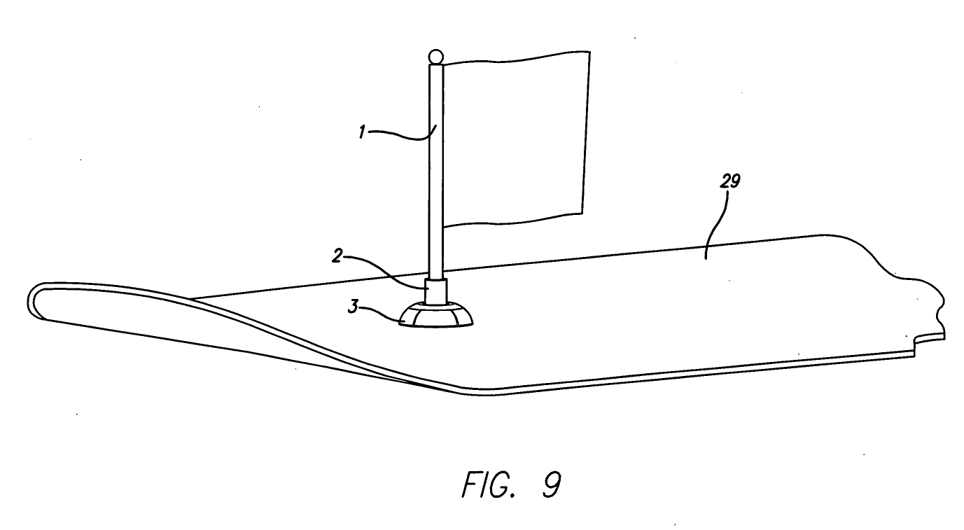

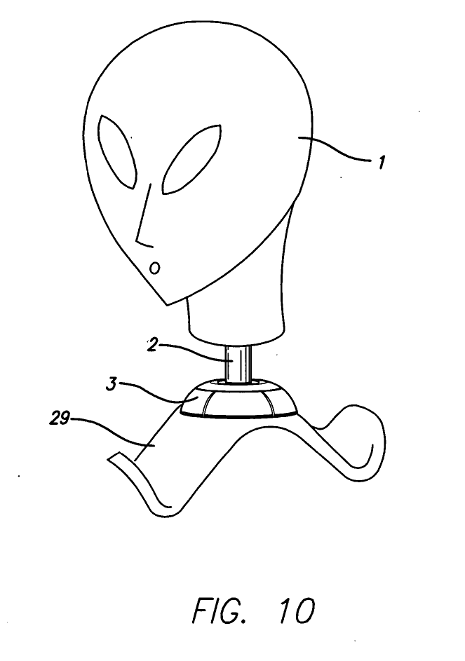

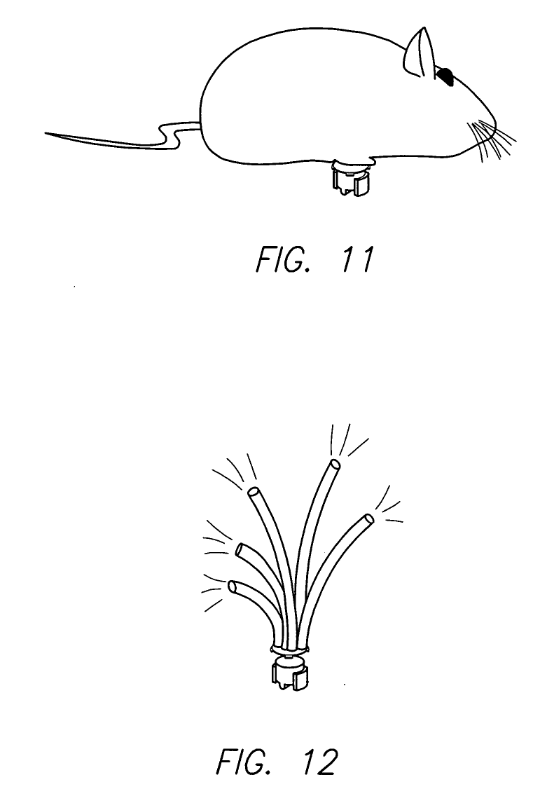

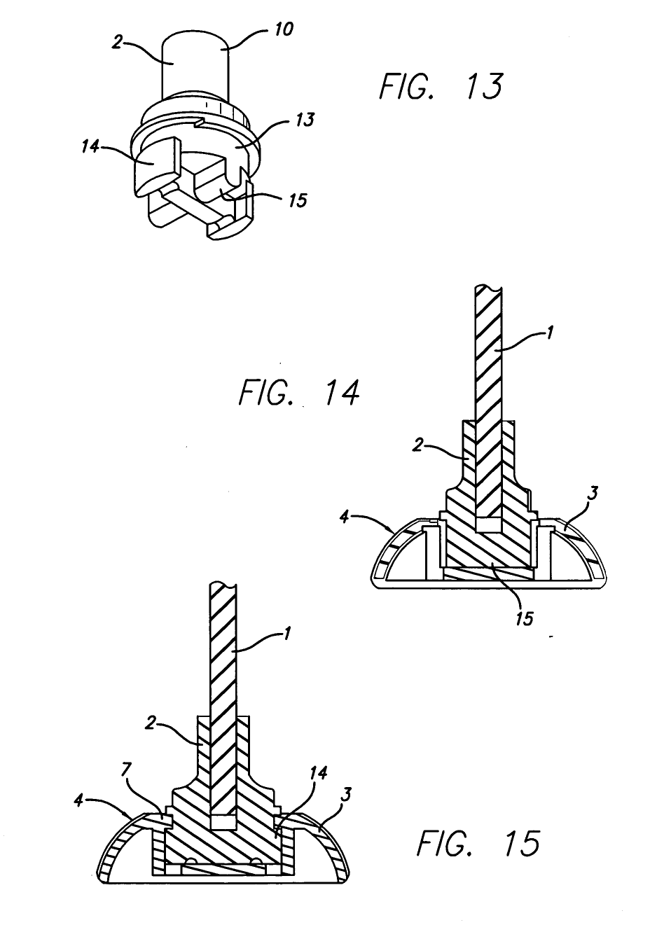

FIG. 9 represents another embodiment of the present invention. The substantially planar surface 29 resembles a skateboard or a snowboard like object. The decorative ornament 1 is a flag and is attached to a coupling device 2. Other examples of substantially planar surfaces are helmets, vehicles, computer monitors, and anything in between, especially, but not limited to, surfaces that are exposed to public access. Yet another embodiment of the present invention is shown in FIG. 10. In this embodiment, the substantially planar surface 29 would use attachment means such as a rubber band to be attached to another substantially planar surface (not shown), such as a scooter.

For use on sporting goods, it is desirable to have the decorative ornament 1 be flexible to minimize any injury lest one would fall on the object. There are many ways to accomplish this. One way is to have the decorative ornament 1 made of a flexible material such as flexible vinyl, urethane or other foam material. In addition to the other coupling devices 2, more rigid articles can be mounted using a flexible coupling such as a spring.

The ornament 1, however need not be flexible and may be rigid. Examples of ornaments that can be used are a flag, a pinwheel, a soft or rigid sculpture, a mounting whistle, and a lighted enclosure with a bulb and battery. While examples of substantially planar surfaces which the mounting base 3 attaches to are skateboards, snowboards, bicycle handles, curved portions of a windshield or spoiler, helmets and computer monitors.

While the present invention has been described with regards to particular embodiments, it is recognized that additional variations of the present invention may be devised without departing from the inventive concept.

What is claimed is:

1. An apparatus attaching at least one novelty ornaments onto a substantially planar surface of a vehicle, comprising:
(a) an elastomeric mounting base comprising an aperture and a flattened bottom surface mounted on said vehicle;
(b) a coupling device having an upper portion and a lower portion, said lower portion having structures detachably attached to said mounting base;
(c) at least one novelty ornament attached to said upper portion of said coupling device;
wherein said mounting base has a convex horizontal upper surface;
wherein said upper surface of said mounting base forms at least one lip that extends into said aperture; and
wherein said coupling device comprises horizontal extensions connected to said lower portion of said coupling device, at least one of said horizontal extensions engaging said at least one lips of said mounting base.

2. An apparatus as set forth in claim 1 wherein said generally planar undersurface of said mounting base securely attaches to said substantially planar surface by a pressure sensitive adhesive.

3. An apparatus as set forth in claim 2, wherein said pressure sensitive adhesive is double sided tape.

4. An apparatus as set forth in claim 2, wherein said pressure sensitive adhesive is a hook and loop fastener.

5. An apparatus as set forth in claim 1 wherein said generally planar undersurface of said mounting base securely attaches to said substantially planar surface by screws or other mechanical fasteners.

6. An apparatus as set forth in claim 1 wherein said substantially planar surface is securely attached to another substantially planar surface by a rubber band.

7. An apparatus as set forth in claim 1, wherein said vehicle is an automobile.

8. An apparatus as set forth in claim 7, wherein said automobile is a car or bicycle.

9. An apparatus as set forth in claim 1, wherein said ornament is made of a rigid material.

10. An apparatus as set forth in claim 1, wherein said coupling device is made of a flexible material.

11. An apparatus attaching at least one novelty ornaments onto a substantially planar surface of a vehicle, comprising:
(a) an elastomeric mounting base comprising an aperture and a flattened bottom surface mounted on said vehicle;
(b) a coupling device having an upper portion and a lower portion, said lower portion having structures detachably attached to said mounting base;
(c) at least one novelty ornament attached to said upper portion of said coupling device;
wherein said mounting base has a convex horizontal upper surface; and
wherein said structures of the lower portion of the coupling device comprise a quarter-turn bayonet-style fastener.

12. An apparatus attaching at least one novelty ornaments onto a substantially planar surface of a vehicle, comprising:
(a) an elastomeric mounting base comprising an aperture and a flattened bottom surface mounted on said vehicle;
(b) a coupling device having an upper portion and a lower portion, said lower portion having structures detachably attached to said mounting base;
(c) at least one novelty ornament attached to said upper portion of said coupling device;
wherein said mounting base has a convex horizontal upper surface; and
further comprising a plurality of ornaments and necks of different shapes and appearances, each of said necks comprising a quarter-turn bayonet-styled fastener to lockingly but removably attach to the mounting base.

13. A decorative combination adorning a vehicle, comprising:
an ornament for adornment of the vehicle, said ornament having a neck portion, said neck portion being of a resilient nature so as to readily bend in the event of a person falling upon the ornament and neck;
a convex-shaped base of a polymeric material having a generally low profile with an aperture generally located on its top surface to receive said neck of an ornament such that said neck is lockingly but removably engaged, said base mountable to a generally flat surface of the vehicle;
wherein the combination of said ornament in assembly with said base is small enough that it avoids interference with the use of the vehicle while still allowing for adornment; and
wherein said neck portion further comprises a quarter-turn bayonet-style fastener for lockingly but removably engaging the convex-shaped base.

14. A decorative combination adorning a vehicle, comprising:
an ornament having a flexible, non-rigid exterior so as not to represent any risk of injury if fallen upon, said ornament having a neck portion integrally formed to the ornament and descending from a bottom surface of the ornament, said neck portion being of a resilient nature so as to readily bend in the event of a person falling upon the ornament and neck;
a convex-shaped base of a polymeric material having a generally low profile with an aperture generally located on its top surface to receive said neck of an ornament such that said neck is lockingly but removably engaged, said base having an adhesively-mountable undersurface to receive double-faced tape or adhesive to adhere to a generally flat surface of the vehicle;
wherein the combination of said ornament in assembly with said base is less than one foot in height to avoid interference with the use of the vehicle while still allowing for adornment;
wherein said neck portion further comprises a quarter-turn bayonet-style fastener for lockingly but removably engaging the convex-shaped base.
